(19) United States
(12) Patent Application Publication
(10) Pub. No.: US 2007/0292652 A1
(43) Pub. Date: Dec. 20, 2007

(54) Apparatus and method for a ferroelectric disk, slider, head gimbal, actuator assemblies, and ferroelectric disk drive

(75) Inventors: Brian D. Strom, Cupertino, CA (US); Na Young Kim, San Jose, CA (US); SungChang Lee, San Jose, CA (US); Vinod Sharma, Los Gatos, CA (US); Joseph Chang, San Jose, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/471,850

(22) Filed: Jun. 20, 2006

(51) Int. Cl. B32B 3/02

(52) U.S. Cl. 428/64.4

(57) ABSTRACT

A ferroelectric disk including disk surfaces and a ground coupling electrically coupled to an electrode sheet covered by a ferroelectric film covered by a probe surface. A slider using a resistive probe for sharing a ground with the ground coupling. A head gimbal assembly including slider interfaced through an amplifier to provide write and read signal to and from the resistive probe. A head stack assembly including at least one head gimbal assembly. A ferroelectric disk drive including the head stack assembly aligned with at least one ferroelectric disk for lateral positioning of the resistive probe near a track on the disk surface of the ferroelectric disk. Access operations for a track by providing voltages between probe sites and ground coupling, for the ferroelectric cell of each bit in track. The bit values of bits in the track, as product of access process.

### TECHNICAL FIELD

This invention relates the utilization of ferroelectric materials in a disk drive, in particular to a ferroelectric disk, the slider, head gimbal assembly, head stack assembly, and a ferroelectric disk drive accessing the ferroelectric disk.

### BACKGROUND OF THE INVENTION

This invention involves the use of a new material being used for a disk in a new kind of disk drive, based upon the ferroelectric effect. Before summarizing the invention, this section will review two primary memory storage architectures and then review the most current research pointing to the invention. A third primary memory architecture involving tape drives is not discussed because it is not seen as relevant to the discussion of this invention.

A hard disk drive implements the first memory architecture, which stems from the inventions of Thomas Edison, and involves a rotating surface, over which an actuator positions a sensor, which may also include a writing device. Starting with the gramophone in the late nineteenth century, this memory architecture has evolved into the modern optical disk drive, removable media disk drives, as well as the hard disk drive, which collectively hold the record for the greatest density of information at the lowest cost per bit, and have throughout most of their history. This architecture tends to support access of data in long strings, often arranged as closed tracks on the rotating surface. As used herein, a track will include at least two sectors.

The second memory architecture stems from the invention of arrays of memory cells arranged to be accessed in a much smaller unit, often called a byte or word. This architecture has been implemented with the ferromagnetic core memories of mid twentieth century, and evolved through various kinds of semiconductor processes into today's flash memory, dynamic and static RAM devices. These tend to serve computers as random access devices or serve as media storage devices emulating disk drives. They have been at the forefront in providing rapid access of data in essentially random addressing patterns.

By way of comparison memory cell arrays emulating disk drives have tended to have smaller overhead, in that typically a column is dealt with at a time. These devices tend to access a column as a fixed length string of bits, which is organized and treated similarly to a sector on a disk drive.

Finally, there is considerable interest in using ferroelectric materials for memory applications, known as ferroelectric memory devices. These devices are known for being non-volatile with very high write-erase cycling before failure. There are reasons to believe that ferroelectric memory cells on the order of nanometers are feasible. Today, the typical application of this memory technology is in a Ferroelectric Random Access Memories, or FRAMs, a memory cell array. Typically, the FRAM is an array of ferroelectric capacitors arranged in cells similar to Dynamic RAM (DRAM) cells, except that the dielectric layer of the DRAM cell is replaced with a ferroelectric film, often composed of ferroelectric material such as lead zirconate titanate. While in general similar to the capacitors used in DRAM cells, the ferroelectric film retains an electric field after the charge in the capacitor drains. This effect is what makes it non-volatile. These cells can be written in under 100 nanoseconds (ns), making them as fast to write as to read and much faster to write than other contemporary non-volatile semiconductor memory cells. Their manufacturing process involves two additional masking steps when compared to normal semiconductor manufacturing processes.

An article entitled “Scanning resistive probe microscopy: Imaging ferroelectric domains” by Park, et. al. in the Applied Physics Letters Volume 84, number 10, pages 1734-1736 reports verifying a resistive probe that could detect a ferroelectric domain at high speed and be used as a read-write head in a probe data storage system, which is incorporated herein by reference. While this research is fundamental and necessary, there remain significant problems to be solved.

The reported current sensitivity of the probe “[I_{R}(V_{G}=1 V)−I_{R}(V_{G}=0 V)]/I_{R}(V_{G}=0 V)” was measured to be 0.3% to 0.5%. The probe signal will need to travel on the order of 10 to 30 centimeters (cm), making it necessary to deal with transmission noise at its destination. Methods and apparatus are needed that strengthen probe sensitivity before transmission.

The article reports asserting 30 volt between the probe site and the electrode on the other side of the ferroelectric film to alter the electric field in a first direction and asserting −30 volts to alter the electric field in a second, opposite direction. This poses a second problem, suppose that the bits to be written on a ferroelectric disk were 5 nanometers (nm) apart, that the ferroelectric disk was 75 millimeters wide and rotates at 6000 revolutions per minute. Assume for the sake of discussion that a track has a circumference of 75 mm and is written with data for every bit it can hold in one revolution. This works out to roughly 150 Million bits written in 1 part of 6000 of a minute, or one hundredth of a second. Put another way, an alternating current signal at a frequency of over one Gigaherz with an amplitude of 30 Volts needs to be provided, again transmitted over the 10 to 30 centimeters. This situation poses a serious potential for problems of inductive coupling and noise. Methods and apparatus are needed to minimize the inductive effects associated with writing data to a track on a ferroelectric disk.

Also in the article, there is a discussion of how the probe was used to polarize the ferroelectric domain. A voltage was applied between the resistive tip of the probe and an electrode of the ferroelectric film to polarize the ferroelectric domain. Applying the voltage to an electrode of a ferroelectric domain measuring 37 cm in radius would bring with it problems. The Ferroelectric film is essentially a capacitor, as mentioned earlier. Methods and apparatus are needed for sharing the electrode. Also, methods and apparatus are needed supporting ferroelectric domain of limited surface area.

### SUMMARY OF THE INVENTION

The invention's ferroelectric disk is for use in at least a ferroelectric disk drive and includes a first disk surface, a second disk surface and at least one ground coupling on the first disk surface and/or the second disk surface. The first disk surface an electrode sheet covered by a ferroelectric film electrically covered by a probe surface facing away from the ferroelectric disk. The electrode sheet is electrically coupled with the ground coupling. The ground coupling may preferably be presented to a disk clamp and/or a disk mount and/or a disk spacer to provide a coupling to a shared ground.

The invention includes the following method of operating the first disk surface. Providing a first voltage between a probe site on the probe surface and the ground coupling causes a ferroelectric cell approximating the vertical footprint of the probe site to sustain a first electric field direction. Providing a second voltage between the probe site and the ground coupling causes the ferroelectric cell to sustain a second electric field direction essentially opposite the first electric field direction, when the second voltage is opposite the first voltage in sign. The electric field of the ferroelectric cell is determined by measuring a sensed current when a third voltage is applied between the probe site and the ground coupling.

Each ferroelectric domain supports forming at least two ferroelectric cells. Each ferroelectric cell sustains its electric field direction in a non-volatile manner. As used herein a memory is volatile if it tends to lose its memory contents when not supplied power on a regular basis, and non-volatile when it retains its memory contents without being supplied power regularly. By way of example, static rams and dynamic rams are volatile memories and ferroelectric and flash memories are non-volatile.

The ferroelectric disk including a first disk surface provides multiple tracks of ferroelectric cells, each track organized as multiple sectors, with each sector belonging to at least one ferroelectric domain. Each ferroelectric domain shares an electrode to its ferroelectric film. Each ferroelectric cell includes a probe site on the ferroelectric film of a ferroelectric domain.

The ferroelectric disk operates as follows: for each of said ferroelectric cells belonging to each of the ferroelectric domains. Providing a first voltage between said probe site and said ground coupling causes said ferroelectric cell to sustain a first electric field direction. Providing a second voltage between said probe site and said ground coupling causes said ferroelectric cell to sustain a second electric field direction essentially opposite said first electric field direction, where said second voltage is opposite said first voltage in sign. The ferroelectric cell sustains its electric field in a non-volatile manner, where the cell does not have to receive energy or power to sustain its electric field direction. Applying a third voltage between the probe site and the ground coupling to measure a memory current indicates whether the ferroelectric cell sustains the first electric field direction, or sustains the second electric field direction.

The invention's head gimbal assembly includes a slider including a resistive probe capable of sensing the electric field near the probe site of the ferroelectric cell of one of the tracks on one of the disk surfaces with respect to a ground shared through the ground coupling with the invention's ferroelectric disk to create a current provided to an amplifier, which provides an amplified read signal when used to read the data contained in the track. The amplifier acts to increase the sensitivity of the probe and reduce the transmission noise effects on the amplified read signal. The head gimbal assembly preferably includes a first micro-actuator assembly coupled to the resistive probe to aid in laterally positioning the resistive probe close to the track.

As used herein, a micro-actuator assembly may use a piezoelectric effect, an electrostatic effect and/or thermal expansion to alter the lateral position and/or the vertical position the resistive probe and/or the second probe above the first and/or the second disk surface.

The ferroelectric disk drive may include more than one ferroelectric disk. Alternatively, the ferroelectric disk drive may support removable ferroelectric disks.

In certain embodiments, the ferroelectric domains may be shared with multiple adjacent tracks on the first disk surface. The ground coupling of the first disk surface may be shared with the second disk surface and/or both disk surfaces may have a ground coupling shared with the other disk surface.

The invention includes an actuator arm coupling to a first head gimbal assembly for access to the first disk surface. These embodiments write to a ferroelectric cell on the first disk surface by providing a voltage between the resistive probe of the first head gimbal assembly close to probe site of the ferroelectric cell and the ground coupling, creating the voltage between the shared electrode and the probe site of the ferroelectric cell, altering its electric field polarity.

The slider and/or the head gimbal assembly may further preferably include a vertical micro-actuator for altering the vertical position of the resistive probe off the disk surface. the ferroelectric disk drive may operate by stimulating the vertical micro-actuator to decrease the vertical position of the resistive probe over the sector and increase the vertical position over the shared contact gap.

The invention includes access operations for a track on a disk surface of the ferroelectric disk by providing voltages between the probe sites and the ground coupling, for the ferroelectric cell of each bit included in the track. The invention includes the bit values of the bits in the track, as a product of that access process.

### BRIEF DESCRIPTION OF THE DRAWINGS

FIGS. 1A and 1B show some details of the invention's slider and a disk surface of the invention's ferroelectric disk;

FIGS. 2 and 3 show some details of the invention's head gimbal assembly in relationship to the ferroelectric disk and the ferroelectric disk drive;

FIGS. 4 and 5A shows further details of the ferroelectric disk drive;

FIG. 5B shows a head gimbal assembly including a micro-actuator assembly using the piezoelectric effect;

FIG. 6 shows an exploded view of some of the components of the ferroelectric disk drive;

FIG. 7 shows a ferroelectric disk drive using more than one disk surface and including more than one disk;

FIGS. 8A and 8B show a micro-actuator assembly employing an electrostatic effect; and

FIG. 9 shows some further details of a head gimbal assembly.

### DETAILED DESCRIPTION

This invention relates the utilization of ferroelectric materials in a disk drive, in particular to a ferroelectric disk, the slider, head gimbal assembly, head stack assembly, and a ferroelectric disk drive accessing the ferroelectric disk.

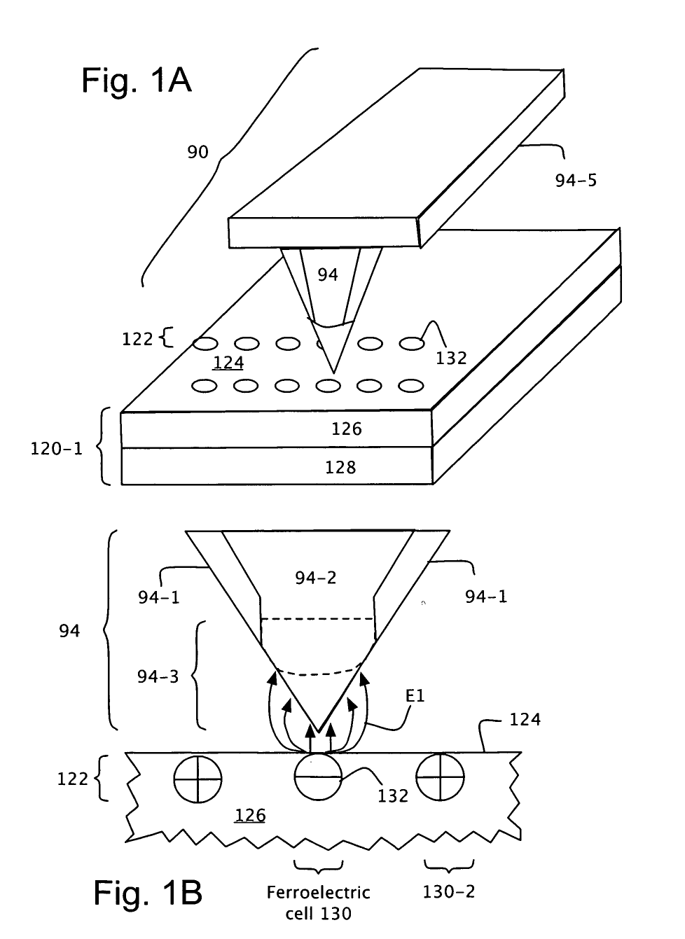

The invention's ferroelectric disk 12 is for use in at least a ferroelectric disk drive 10 and includes a first disk surface 120-1 and a second disk surface 120-2. The first disk surface includes at least one ferroelectric film 126 electrically coupled to a probe surface 124 facing away from the ferroelectric disk and sharing an electrode sheet 128 with a ground coupling 136. The ground coupling may preferably be presented to a disk clamp 131 and/or a disk mount 129 and/or a disk spacer 134 to provide a coupling to a ground shared with the slider 90, as shown in FIGS. 1A to 5A.

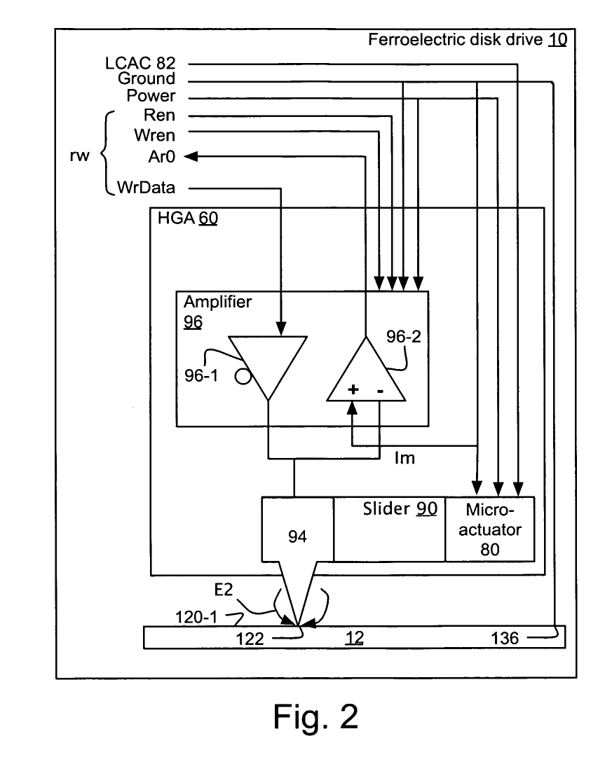

The invention includes the following method of accessing data 122 stored on a disk surface, for example, the first disk surface 120-1. A first voltage is provided between a probe site 132 on the probe surface 124 and the ground coupling 136, causing a ferroelectric cell 130 approximating the vertical footprint of the probe site to sustain a first electric field direction E1, as shown in FIG. 1B. Providing a second voltage between the probe site and the ground coupling causes the ferroelectric cell to sustain a second electric field direction E2 essentially opposite the first electric field direction, when the second voltage is opposite the first voltage in sign as shown in FIG. 2. The electric field of the ferroelectric cell is determined by measuring a sensed current when a third voltage is applied between the probe site and the ground coupling.

The ferroelectric film 126 may include a concentration, essentially consisting of the group of elements in a mixture: lead (Pb), zirconium (Z), titanium (Ti), and oxygen (O). These elements may further form a compound, and the ferroelectric film may preferably include the Pb(Zr_{0.4}Ti_{0.6})O₃ compound. The concentration may preferably be at least ninety percent of the molecular weight of the ferroelectric film.

The first disk surface 120-1 of the ferroelectric disk 12 includes at least two instances of the ferroelectric cell 130, for example as shown in FIG. 1B including a second ferroelectric cell 130-2. Each ferroelectric cell sustains its electric field direction in a non-volatile manner. As used herein a memory is volatile if it tends to lose its memory contents when not supplied power on a regular basis, and non-volatile when it retains its memory contents without being supplied power regularly. By way of example, static rams and dynamic rams are volatile memories and ferroelectric and flash memories are non-volatile.

The ferroelectric disk 12 including the first disk surface 120-1 preferably provides multiple tracks of ferroelectric cells, each track 122 organized as multiple sectors, with each sector including at least one ferroelectric cell 130, preferably arranged as a payload of N ferroelectric cells and an envelope of M ferroelectric cells, where N is typically a power of two, often at least 2̂8=256, and M is sufficient for the envelope to function as the coding overhead for an error correcting/detecting coding scheme. Each ferroelectric cell includes a probe site 132 on the ferroelectric film 126.

The ferroelectric disk 12 operates as follows: for each ferroelectric cell 130, providing a first voltage between said probe site 132 and said ground coupling 136 causes said ferroelectric cell to sustain a first electric field direction E1. Providing a second voltage between said probe site and said ground coupling causes said ferroelectric cell to sustain the second electric field direction E2 essentially opposite said first electric field direction, where said second voltage is opposite said first voltage in sign. The ferroelectric cell sustains its electric field in a non-volatile manner, where the cell does not have to receive energy or power to sustain its electric field direction. Applying a third voltage between the probe site and the ground coupling to measure a memory current Im indicates whether the ferroelectric cell sustains the first electric field direction, or sustains the second electric field direction.

The invention's head gimbal assembly 60 includes a slider 90 including a resistive probe 94 capable of sensing the electric field near the probe site 132 of the ferroelectric cell 130 of a track 122 on a disk surface with respect to a ground shared through the ground coupling 136 with the invention's ferroelectric disk 12 to create the memory current Im provided to an amplifier 96, which provides an amplified read signal Ar0 when used to read the data contained in the track. The amplifier acts to increase the sensitivity of the probe and reduce the transmission noise effects on the amplified read signal. The head gimbal assembly preferably includes a micro-actuator assembly 80 coupled to the resistive probe to aid in laterally positioning Lp the resistive probe close to the track.

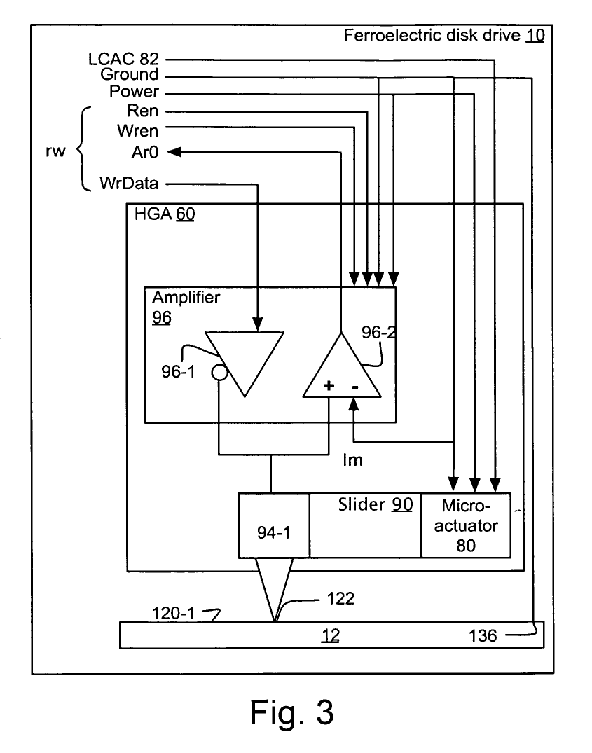

The resistive probe 94 is preferably conical in shape, as shown in FIGS. 1A and 1B, and includes a resistive region 94-3 composed of a low doped n+ type material electrically couples to a p-type region 94-2 and connected to metal pads on the cantilever 94-5 through highly doped n-type regions 94-1 on the incline, which electrically couples the resistive probe to the amplifier 96, as shown in FIGS. 2 and 3.

The resistive probe 94 operates as follows. The resistive region 94-3 is much higher in resistance than the highly doped regions 94-1, it acts as a small resistor at the tip of the resistive probe. When the tip approaches the ferroelectric material, electrons, as the majority carriers in the resistive region are depleted by the electric field E1 from the negative surface charges as shown in FIG. 1B. The depletion of the majority carriers alters the volume of the conducting path of the resistive region, resulting in a resistance change.

Alternatively, the majority carriers are accumulated in the resistive region by the second electric field E2 from the positive surface charges as shown in FIG. 2. The accumulation of majority carriers alters the carrier density of the conducting path in the resistive region 94-3, also resulting in a resistance change.

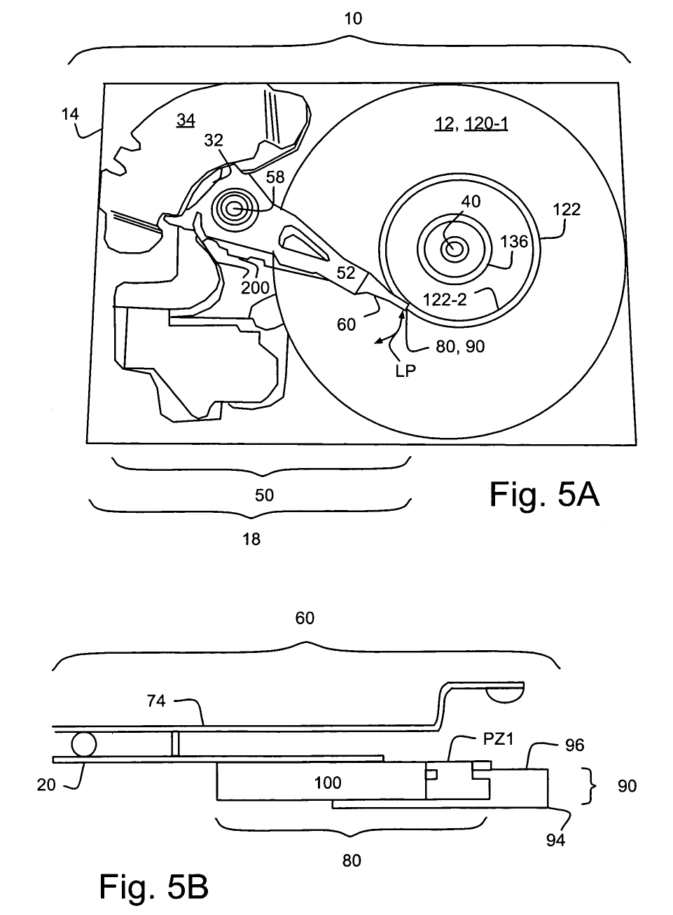

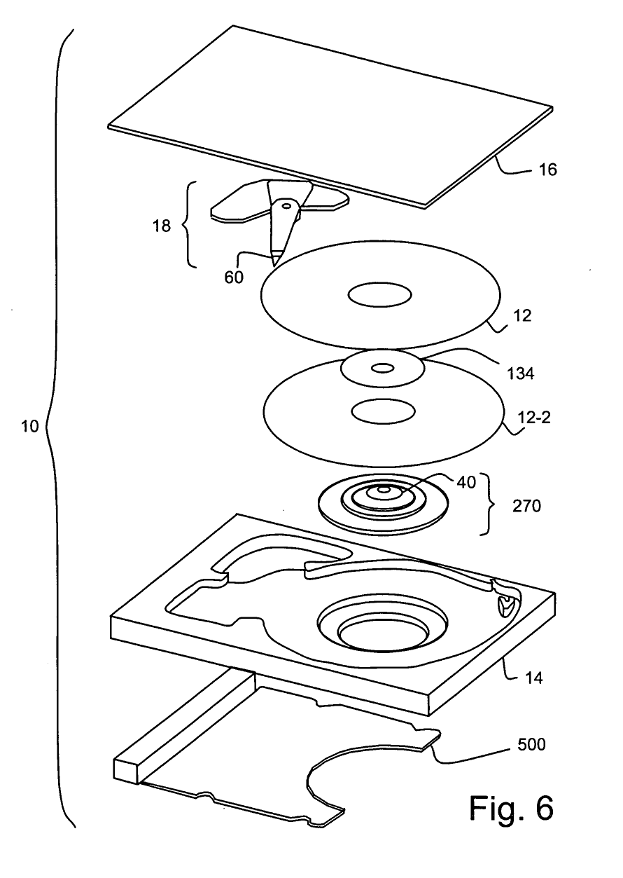

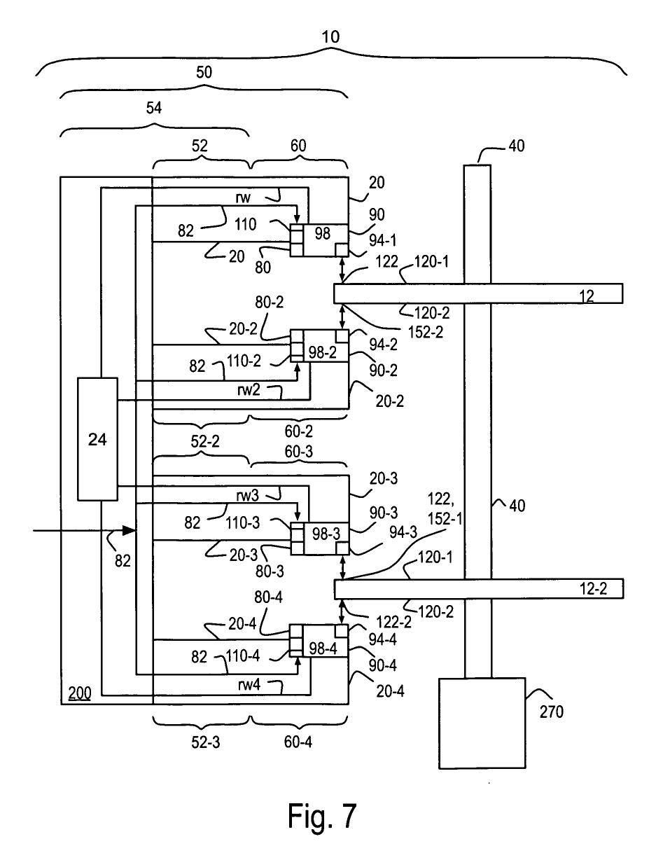

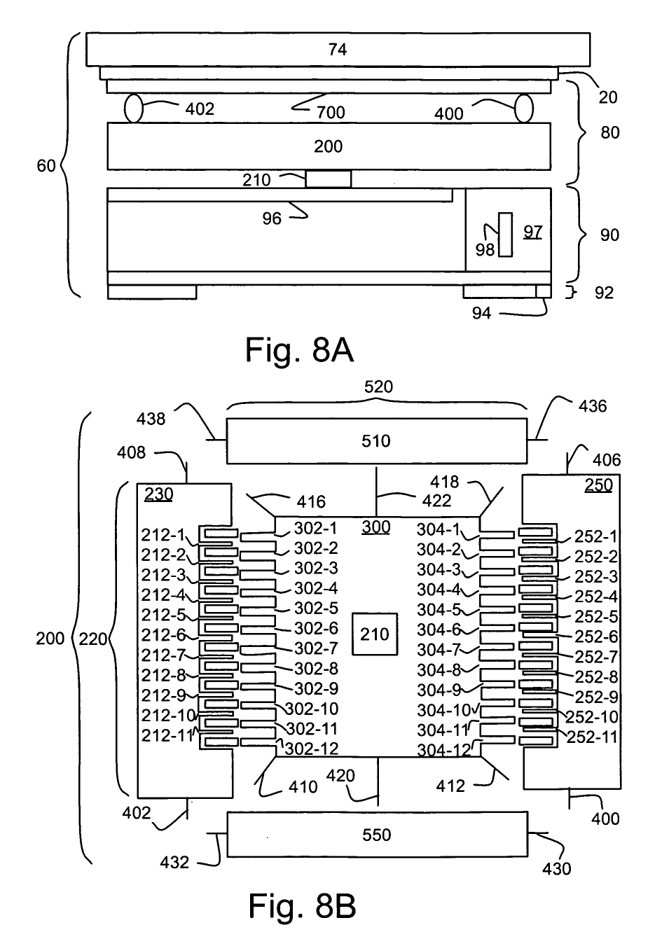

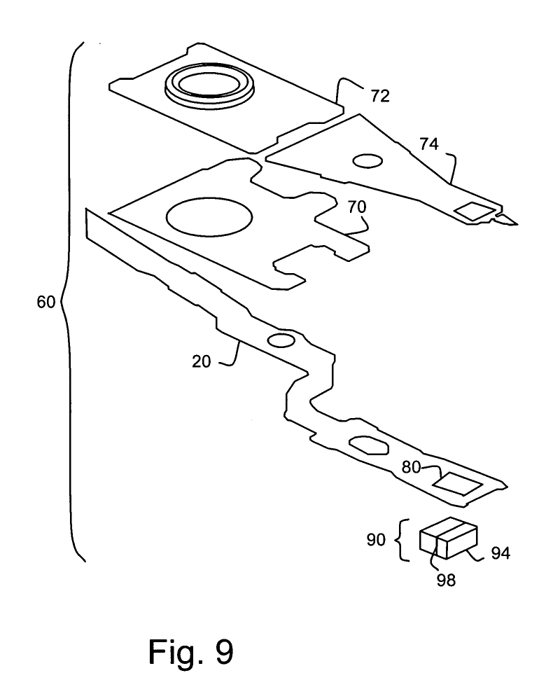

As used herein, a micro-actuator assembly 80 may use a piezoelectric effect PZT as shown in FIG. 5B and/or an electrostatic effect as shown in FIGS. 8A and 8B to alter the lateral position LP and/or a thermal effect as shown by the vertical micro-actuator 98 embedded in the slider 90 as shown in FIGS. 7 and 8A.

The ferroelectric disk drive 10 may include more than one ferroelectric disk, as shown in FIG. 7, where the ferroelectric disk drive includes a second ferroelectric disk 12-2. Alternatively, the ferroelectric disk drive may support a removable ferroelectric disk 12.

In certain embodiments, the ground coupling 136 of the first disk surface 120-1 may be shared with the second disk surface 120-2 and/or both disk surfaces may have a ground coupling shared with the other disk surface.

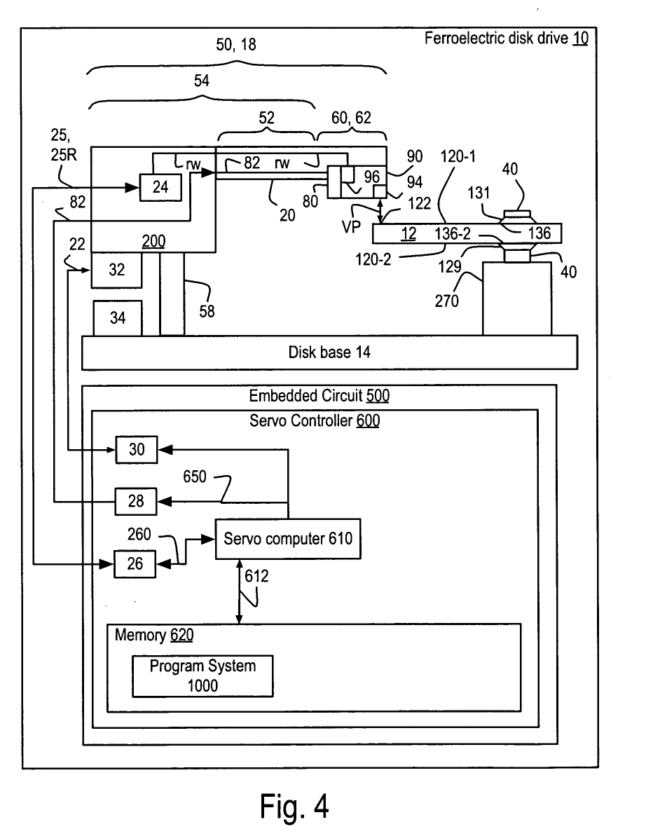

The invention includes an actuator arm 52 coupling to a first head gimbal assembly 60 for access to the first disk surface 120-1 as shown in FIGS. 4, 5A, and 7.

The invention includes a head stack assembly 54 with an actuator arm 52 coupling to a first head gimbal assembly 60 for access to the first disk surface 120-1. The head stack assembly may further couple to a second head gimbal assembly 60-2 for access to the second disk surface 120-2 as shown in FIG. 7.

The slider 90 and/or the head gimbal assembly 60 may further preferably include a vertical micro-actuator 98 for altering the vertical position VP of the resistive probe 94 off the disk surface. The ferroelectric disk drive 10 may operate by stimulating the vertical micro-actuator to decrease the vertical position of the resistive probe over the sector and increase the vertical position over the shared contact gap.

In further detail, a head gimbal assembly 60 preferably includes a load beam 74 mechanically coupling through a hinge 70 to a base plate 72, which is coupled to an actuator arm 52, often using a swaging process. The slider 90 is mechanically coupled to the micro-actuator assembly 80, both of which coupled to a flexure finger 20. The flexure finger preferably provides the read-write signal bundle rw between the slider and its amplifier 96, which acts as an interface to the resistive probe 94. The flexure finger is typically coupled to the load beam.

The head stack assembly 50 includes the head stack 54 containing at least one actuator arm 52, as shown in FIGS. 4 and 5A. It may preferably include more than one actuator arm, as shown in FIG. 7. An actuator arm may be coupled to more than one head gimbal assembly, for example, the second actuator arm 52-2 is coupled to a second head gimbal assembly 60-2 and a third head gimbal assembly 60-3. The head stack not only includes the second actuator arm, but also the third actuator arm 52-3 coupled to the fourth head gimbal assembly 60-4.

The head stack assembly 50 further includes a voice coil 32 rigidly coupled through the head stack 54 and its actuator arm 52 to the head gimbal assembly 60. The ferroelectric disk drive 10 further includes the head stack assembly 50 rotatably coupled through an actuator pivot 58 to the disk base 14 and positioned near at least one fixed magnet 34 and aligned so that the head gimbal assembly can be laterally positioned LP over the disk surface, shown in the Figures as the first disk surface 120-1 of the ferroelectric disk 12. The voice coil motor 18 includes the head stack assembly, fixed magnet and disk mounted to the spindle shaft 40 of the spindle motor 270.

Operating the ferroelectric disk drive includes the following. The spindle motor 270 is directed by the embedded circuit 500 to rotate the ferroelectric disk 12, preferably bringing it up to a nearly constant rotational velocity. The ground coupling 136 of the first disk surface 120-1 electrically couples through at least one of the disk mount 129, the disk clamp 131 and/or a disk spacer 134 sharing a ground provided to the slider 90 and its amplifier 96. Accessing the data of a track 122 includes stimulating the voice coil 32 with a voice coil control signal 22 delivering a time varying electric signal to the voice coil, which interacts with the fixed magnet to alter the lateral position LP of the slider until it is near the track. The voice coil control signal is provided by a voice coil driver 30 included in the embedded circuit. While the micro-actuator assembly may be employed during this track seek operation, it most significant once the slider is close to the track, which is often referred to as the track following mode. During track following mode, the read-write signal bundle rw stimulates a preamplifier 24 to at least partly create the read-write signals 25, in particular the read signal 25-R, which is received by the channel interface 26. The channel interface may preferably provides a Position Error Signal 650 to a servo controller 600, which may preferably be responsible for stimulating the voice coil motor and the micro-actuator assembly 80 to control the lateral position of the resistive probe to keep it near the track.

The servo controller 600 may preferably include a servo computer 610 accessibly coupled 612 a servo memory 620, in which a program system 1000 resides as a collection of program steps.

Consider the second problem posed by the prior art. Again suppose that the bits to be written on a ferroelectric disk were 5 nanometers (nm) apart, that the ferroelectric disk was 75 millimeters wide and rotates at 6000 revolutions per minute. Assume for the sake of discussion that a track has a circumference of 75 mm. The high voltage swings in certain embodiments may be handled by writing at a lower speed than reading. By way of example, providing the third voltage between the probe site 132 and the ground coupling 136 to read the bit value from the bit may be performed at a read-rate and providing the voltage to write the bit value into the bit may be performed at a fraction of the read-rate, where the fraction is less than one. By way of a further example, writing the track 122 may be performed in more than one revolution, say K revolutions. This works out to roughly 150 Million bits written in K parts of 6000 of a minute, or K hundredths of a second. Put another way, an alternating current signal at a frequency of over one Gigaherz divided by K with an amplitude of 30 Volts needs to be provided, again transmitted over the 10 to 30 centimeters. K may be preferred to be essentially an integer, for example, perhaps 2, 3, 4, and so on.

The preceding embodiments provide examples of the invention and are not meant to constrain the scope of the following claims.

What is claimed is:

1. A ferroelectric disk for use in a ferroelectric disk drive, comprising:
a first disk surface, a second disk surface and at least one ground coupling on at least one member of the disk surface group consisting of said first disk surface and said second disk surface;
wherein for at least one member of said disk surface group, said member includes an electrode sheet covered by a ferroelectric film covered by a probe surface;
wherein said electrode sheet is electrically coupled to said ground coupling;
wherein providing a first voltage between a probe site on said probe surface and the ground coupling causes a ferroelectric cell approximating the vertical footprint of said probe site to sustain a first electric field direction; and
wherein providing a second voltage between said probe site and said ground coupling causes said ferroelectric cell to sustain a second electric field direction essentially opposite the first electric field direction, when said second voltage is opposite said first voltage in sign.

2. The ferroelectric disk of claim 1, wherein said ferroelectric film includes a concentration, essentially consisting of the group of elements in a mixture: a lead (Pb), a zirconium (Z), a titanium (Ti), and an oxygen (O).

3. The ferroelectric disk of claim 2, wherein said ferroelectric film includes a concentration, essentially consisting of said group of said elements in a compound.

4. The ferroelectric disk of claim 3, wherein said compound is a Pb(Zr_{0.4}Ti_{0.6})O₃ compound.

5. The ferroelectric disk of claim 3, wherein said concentration is at least ninety nine percent.

6. The ferroelectric disk of claim 3, wherein said elements in said group of elements, forms at least ninety percent of the molecular weight of said compound.

7. The ferroelectric disk of claim 1,
wherein said first disk surface includes a succession of at least two tracks, each of said tracks organized into at least two sectors, each of said sectors including at least two of said ferroelectric cells;
wherein for each of said ferroelectric cells, said ferroelectric cell is included in at most one of said tracks.

8. A head gimbal assembly for accessing said tracks of said ferroelectric disk of claim 7, comprising: a slider containing a resistive probe providing at least one probe signal to an amplifier to provide an amplified read signal based upon said resistive probe sensing said electric field direction sustained by said ferroelectric cells of said track.

9. The head gimbal assembly of claim 8, wherein said amplifier receives a write data signal and a read-write indication;
wherein said amplifier further provides said amplified read signal when said read-write indication indicates a read access; and
wherein said amplifier asserts said probe signal as an amplification of said write data signal when said read-write indication indicates a write access.

10. The slider of claim 8, further comprising: said amplifier.

11. A head stack assembly for said ferroelectric disk of claim 8, comprising:
at least one head gimbal assembly coupled to an actuator arm included in a head stack.

12. The head stack assembly of claim 11, further comprising: a voice coil coupled to said head stack.

13. The ferroelectric disk drive of claim 11, comprising:
said head stack assembly aligned with at least one of said ferroelectric disks to permit lateral positioning of said slider and said probe near said track of said first disk surface.

14. A method of accessing a track on said disk surface included in said ferroelectric disk drive of claim 13, comprising the step:
providing a voltage between said probe site of said ferroelectric cell and said ground coupling to access a bit stored in said ferroelectric cell, for each of said bits included in said track, further comprising, for each of said bits included in said track, the steps:
providing said voltage between said probe site and said ground coupling to write a bit value into said bit; and
providing a third voltage between said probe site and said ground coupling to read said bit value from said bit.

15. The method of claim 14, wherein the step providing said voltage to write to said bit, further comprising the steps:
providing said first voltage between said probe site and said ground coupling to cause said ferroelectric cell to sustain said first electric field direction when said bit value is 0; and
providing said second voltage between said probe site and said ground coupling to cause said ferroelectric cell to sustain said second electric field direction essentially opposite the first electric field direction, when said second voltage is opposite said first voltage in sign and said bit value is 1.

16. The method of claim 15, wherein the step providing said third voltage between said voltage to read said bit value from said bit, further comprises the steps:
asserting said read-write indication to indicate said read access to said amplifier; and
said amplifier providing said amplifier read signal to create said bit value from a sensed current determined by said electric field of said ferroelectric cell of said bit.

17. The bit values of said bits included in said track, as a product of the process of claim 14.

18. The method of claim 14, wherein the step providing said third voltage, further comprises the step:
providing said third voltage between said probe site and said ground coupling to read said bit value from said bit at a read-rate;
providing said voltage between said probe site and said ground coupling to write said bit value into said bit at a fraction of said read-rate; wherein said fraction is less than one.
